(19) United States
(12) Patent Application Publication
(10) Pub. No.: US 2025/0205108 A1
(43) Pub. Date: Jun. 26, 2025

(54) Portable Automatic Shirodhara Device

(71) Applicants: Rekha Ganesh Kotyan, Bangalore (IN); Archana C, Bengaluru (IN); Gagan S Poojari, Udupi (IN)

(72) Inventors: Rekha Ganesh Kotyan, Bengaluru (IN); Archana C, Bengaluru (IN); Gagan S Poojari, Udupi (IN); Sampath Pavan Kumar, Bengaluru (IN)

(73) Assignees: Rekha Ganesh Kotyan, Bangalore (IN); Archana C, Bengaluru (IN); Gagan S Poojari, Udupi (IN)

(21) Appl. No.: 18/985,063

(22) Filed: Dec. 18, 2024

(30) Foreign Application Priority Data
Dec. 20, 2023 (IN) 202341087119

(51) Int. Cl. A61H 9/00

(52) U.S. Cl. CPC A61H 9/0021; A61H 2201/0138; A61H 2201/0157; A61H 2201/0207; A61H 2201/1246; A61H 2201/1607; A61H 2201/1678; A61H 2201/5097; A61H 2205/025

(57) ABSTRACT

A portable shirodhara device (200) comprising: a fluid heater unit 202 configured with a temperature and a timer sensors warms up a selected fluid administered into a fluid container unit 203 constantly to desirable temperature preferably 38° C. and maintains the same temperature till the entire process of treatment; a fluid container unit 203 with a selected fluid usually oil or combination of oils, milk, buttermilk or water based on the subject's body requirements and condition; a fluid dispenser unit 205 flows the warmed fluid on the adjusted forehead just four fingers above the subject's forehead in a rhythmic pendulum motion in lateral direction; a fluid collection unit 208 used to collect the fluid that flows from the fluid dispenser unit 205 above the subject's forehead; a remote-control unit 211 connected to the portable shirodhara device 200 through Bluetooth or WIFI to control the entire operation of the device remotely, wherein the portable shirodhara device 200 is used to achieve a minimizing usage of fluids and man power for the procedure of shirodhara treatment.

### CROSS REFERENCES TO RELATED APPLICATION

This application claims Priority from Indian Patent Application number 202341087119 filed on Dec. 20, 2023 which is incorporated herein in its entirety by reference.

### BACKGROUND

### Technical Field

The present invention relates to a shirodhara device and more particularly to method and system to develop a portable automatic efficient shirodhara device to achieve a minimizing usage of fluids and man power for the procedure of shirodhara treatment.

### Related Art

A shirodhara is an ayurvedic healing technique that involves where someone pours liquid usually oil, milk, buttermilk or water onto forehead. It's often combined with a body, scalp or head massage. This healing method focuses on rebalancing the life focus called ‘doshas’ within the body. This shirodhara method gives relaxing, soothing and calming effects on the body and mind and also helps in improving sleep quality, manage insomnia, lessen anxiety with reducing stress.

The shirodhara ayurvedic treatment is performed by a well trained professional where a person is asked to lie on his/her back and relax. Next, the practitioner heats up the liquid or fluid which roughly matches the person body temperature and places it in abowl. The professional holds the bowl fitted to a stand over the person's head. The liquid gently drips through a small hole at the bottom of the bowl either way landing between the eyebrows.

The conventional devices used to perform shirodhara healing method is not portable and so efficient as it requires man intervention and also involves the liquid being too hot or chances of getting into eyes.

Hence, an effective and an efficient portable shirodhara device is required to achieve a minimizing usage of fluids and man power for the procedure of shirodhara treatment.

### SUMMARY

In one embodiment, a portable shirodhara device comprising: a control unit to control the entire operation of the device; a fluid heater unit configured with a temperature and a timer sensors warms up a selected fluid administered into a fluid container unit constantly to desirable temperature preferably 38° C. and maintains the same temperature till the entire process of treatment; a fluid container unit with a selected fluid usually oil or combination of oils, milk, buttermilk or water based on the subject's body requirements and condition; a motor unit to pump the warmed fluid from the fluid container unit to a fluid dispenser unit; a fluid dispenser unit flows the warmed fluid on the adjusted forehead just four fingers above the subject's forehead in a rhythmic pendulum motion in lateral direction; a pendulum motion unit makes the fluid dispenser unit to allow the fluid flow either perpendicularly or across or in a rhythmic pendulum motion on the subject's forehead; a head rest unit where the subject's head is rested for the fluid to flow from the fluid dispenser unit on the forehead just four fingers above the subject's forehead; a fluid collection unit used to collect the fluid that flows from the fluid dispenser unit above the subject's forehead; a pump unit used to pump the collected fluid from the fluid collection unit back to the fluid container unit which gets warmed again by the fluid heater unit and pumped to the fluid dispenser unit; a power unit provides power from the external sources to activate the entire operation of the portable shirodhara device; a remote-control unit connected to the portable shirodhara device through Bluetooth or WIFI to control the entire operation of the device remotely, wherein the portable shirodhara device is used to achieve a minimizing usage of fluids and man power for the procedure of shirodhara treatment.

Several aspects are described below, with reference to diagrams. It should be understood that numerous specific details, relationships, and methods are set forth to provide a full understanding of the present disclosure. One who skilled in the relevant art, however, will readily recognize that the present disclosure is practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1 is a schematic view illustrating a conventional shirodhara device.

FIG. 2A is a block diagram illustrating a portable shirodhara device in an embodiment of the present disclosure.

FIG. 2B through FIG. 2C are schematic views illustrating a portable shirodhara device in an embodiment of the present disclosure.

FIG. 3 is a schematic view illustrating the shirodhara healing method is performed using the portable shirodhara device in an embodiment of the present disclosure.

FIG. 4A and FIG. 4B are schematic view illustrating the head position during shirodhara healing is performed using the portable shirodhara device in an embodiment of the present disclosure.

FIG. 5A through FIG. 5C are schematic view of the pendulum motion unit illustrating the dispensing bowl movement of the portable shirodhara device in an embodiment of the present disclosure.

### DETAILED DESCRIPTION OF THE PREFERRED EXAMPLES

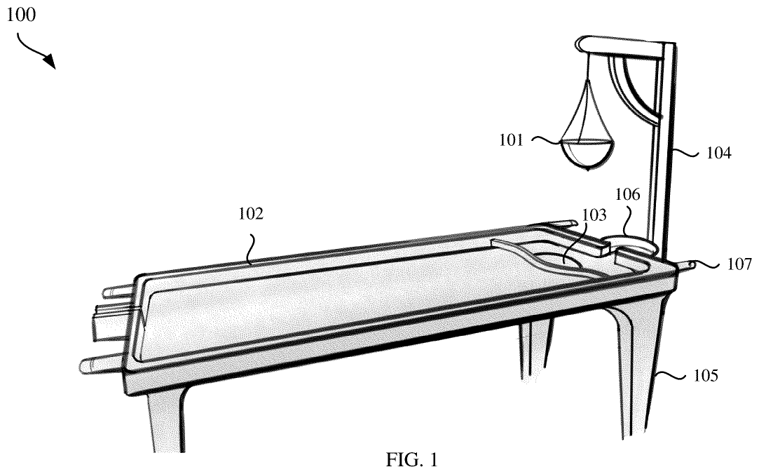

FIG. 1 is a schematic view illustrating a conventional shirodhara device. As shown in 100, is shirodhara device used for the shirodhara ayurvedic healing technique which comprises of a shirodhara bowl 101 where a selected fluid is administered based on the subject's body requirements and condition. Most of the cases require the use of oil or a combination of oils. A scalp massage is administered followed by full body massage. As the subject is advised to lie down on a shirodhara table 102 in supine position where the head is rested on the head rest position 103 of the shirodhara device 100 supported with a table rigid legs 105. The height of the shirodhara bowl 101 is adjusted on the forehead just four fingers (4 Angola˜approximately. 6 inches) above the subject's forehead. The trained professional warms up the selected fluid (heats the oil to a predefined temperature) to desirable temperature (preferably 38° C.) and poured in to the shirodhara bowl 101 hanged to a shirodhara bowl support stand 104. Then the shirodhara bowl 101 is kept in a rhythmic pendulum motion. As the fluid level in the shirodhara bowl 101 gets reduced due to continuous flow, the rate of flow decreases gradually and gets collected in a collection tray 106. The oil temperature also reduces. The stream flow rhythm of the fluid changes which becomes small and slow. The collected fluid in the collection tray 106 is either reused or thrown away. The shirodhara bowl 101 has to be refilled with fluid and maintained in the oscillatory movements all the time depending on the prescribed time of treatment.

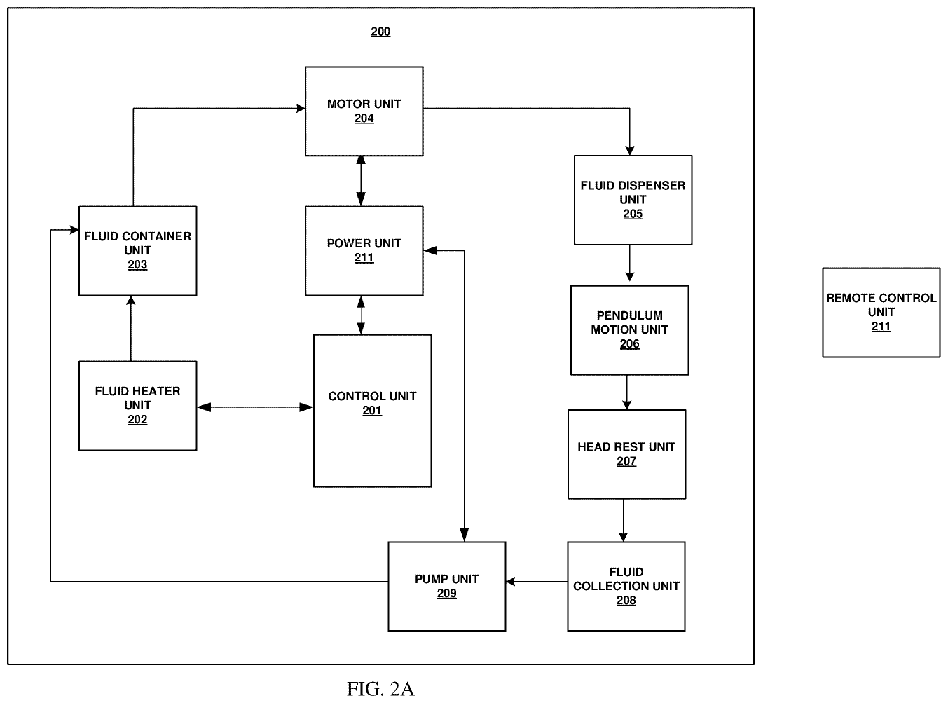

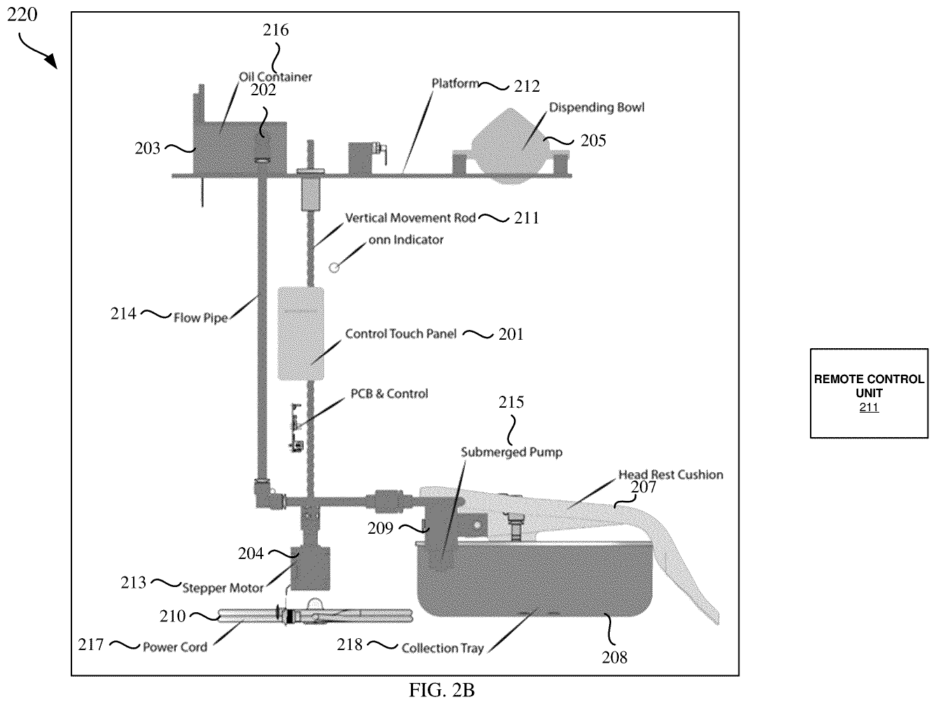

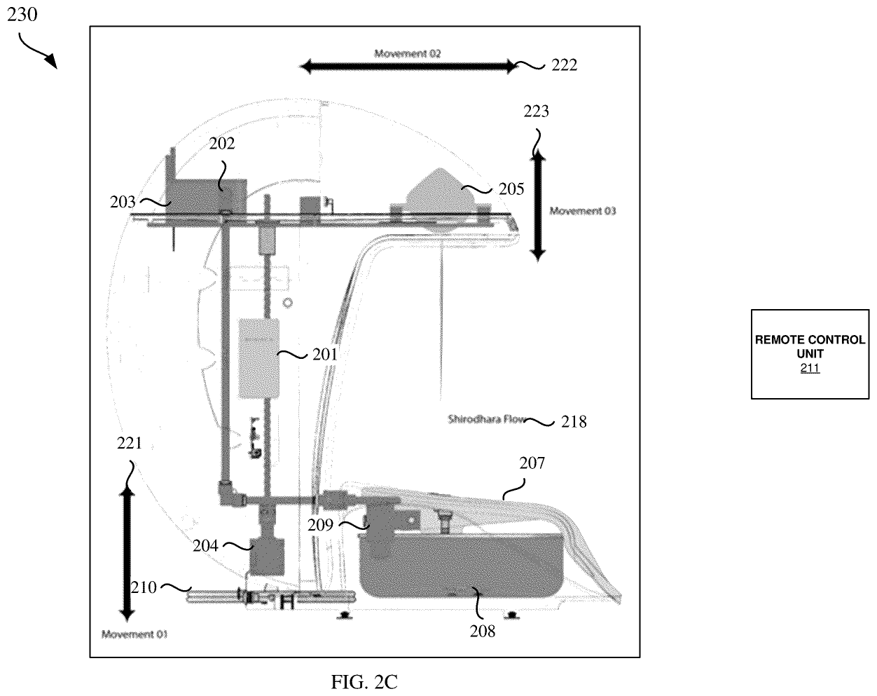

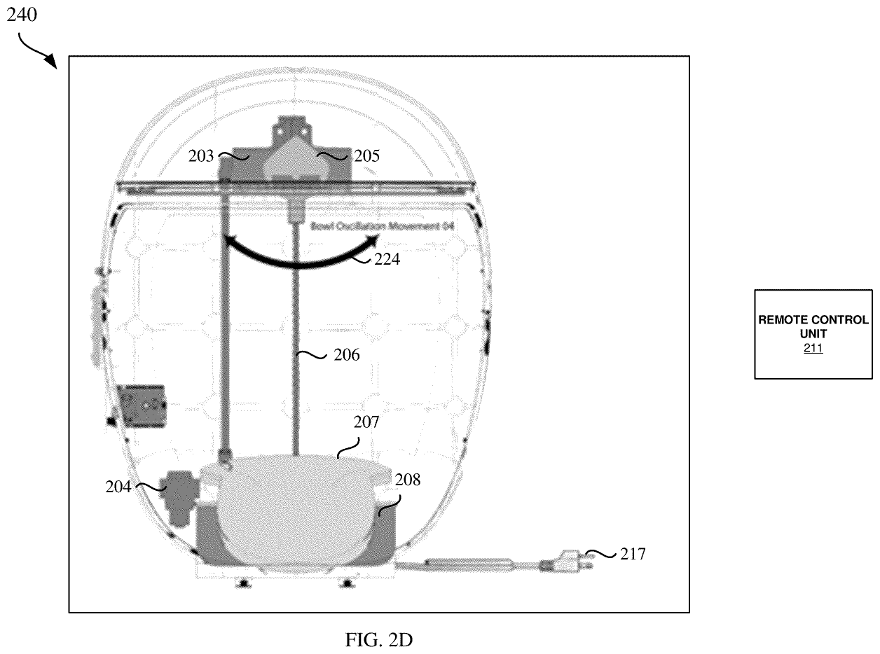

FIG. 2A is a block diagram illustrating a portable shirodhara device in an embodiment of the present disclosure. As shown in 200, is a portable shirodhara device used to achieve the operational requirement efficiently at the same time minimizing usage of fluids and man power for the procedure of shirodhara treatment. It comprises of a control unit 201, a fluid heater unit 202, a fluid container unit 203, a motor unit 204, a fluid dispenser unit 205, a head rest unit 206, a fluid collection unit 207, a pump unit 208, a power unit 209, a remote-control unit 210 and a pendulum motion unit 211. Each unit is explained in detail below.

The control unit 201 is used to control the entire operation of the device.

The fluid heater unit 202 configured with a temperature and a timer sensors warms up a selected fluid administered into a fluid container unit 203 to desirable temperature preferably 38+ or −5° C. and to maintains the same temperature till the entire process of treatment.

The fluid container unit 203 that contains a selected fluid usually oil or combination of oils, milk, buttermilk or water based on the subject's body requirements and condition.

The motor unit 204 to pump the warmed fluid from the fluid container unit 203 to a fluid dispenser unit 205.

The fluid dispenser unit 205 flows the warmed fluid on the adjusted forehead just four fingers (4 Angola˜approximately. 6 inches) above the subject's forehead in a rhythmic pendulum motion in lateral direction.

The pendulum motion unit 206 makes the fluid dispenser unit 205 to allow the fluid flow either perpendicularly or across or in a rhythmic pendulum motion on the subject's forehead.

The head rest unit 207 where the subject's head is rested for the fluid to flow from the fluid dispenser unit 205 on the forehead just four fingers (4 Angola˜approximately. 6 inches) above the subject's forehead.

The fluid collection unit 208 is used to collect the fluid that flows from the fluid dispenser unit 205 above the subject's forehead.

The pump unit 209 used to pump the collected fluid from the fluid collection unit 207 back to the fluid container unit 203 which gets warmed again by the fluid heater unit 202 and pumped to the fluid dispenser unit 205.

The power unit 210 provides power from the external sources to activate the entire operation of the portable shirodhara device 200.

The remote-control unit 211 connected to the portable shirodhara device 200 through Bluetooth or WIFI to control the entire operation of the device remotely.

FIG. 2B through FIG. 2D are schematic views illustrating a portable shirodhara device in an embodiment of the present disclosure. As shown in 220, 230 and 240, is a portable shirodhara device used to achieve a minimizing usage of fluids and man power for the procedure of shirodhara treatment. It comprises of a control unit 201 with control touch panel is used to control the entire operation of the device through vertical movement rod 211. The fluid heater unit 202 warms up the selected fluid administered in a fluid container unit 203 constantly to desirable temperature preferably 38+ or −5° C. and maintains the same temperature till the entire process of treatment by the control unit 201. The fluid container unit or oil container 203 that contains a selected fluid usually oil or combination of oils, milk, buttermilk or water based on the subject's body requirements and condition. The motor unit 204 with stepper motor 213 to pump the warmed fluid from the fluid container unit 203 to a fluid dispenser unit 205 through platform 212. The fluid dispenser unit 205 with dispensing bowl flows the warmed fluid either perpendicularly or across or in a rhythmic pendulum motion using pendulum motion unit on the subject's forehead. The head rest unit 207 with head rest cushion 216 where the subject's head is rested for the fluid to flow (called as shirodhara flow 218) from the fluid dispenser unit 205 on the forehead just four fingers (4 Angola˜approximately. 6 inches) above the subject's forehead. The fluid collection unit 208 with collection tray 218 is used to collect the fluid that flows from the fluid dispenser unit 205 above the subject's forehead. The pump unit 209 with submerged pump 215 used to pump the collected fluid from the fluid collection unit 208 back to the fluid container unit 203 through flow pipes 214 which gets warmed again by the fluid heater unit 202 and pumped to the fluid dispenser unit 205. Its continuous process up to 15-20 minutes. The power unit 209 with power chord 217 to activate the entire operation of the portable shirodhara device 200. The remote-control unit 211 connected to the portable shirodhara device 200 through Bluetooth or WIFI to control the entire operation of the device remotely.

In an embodiment, the oil from the oil container flows down to subject's forehead gets collected in tray is again pumped into oil container. Its continuous process up to 15-20 minutes.

As shown in 230, the dispensing bowl of the fluid dispenser unit 205 which is pivoted on both sides. The dispensing bowl gets tilted upwards indicated as movement 01 (221) and then towards right direction as movement 02 (222) and then downwards as movement 03 (223) so that the warmed fluid flows on the adjusted forehead either perpendicularly or across the subject's forehead.

As shown in 240, the dispensing bowl of the fluid dispenser unit 205 pivoted on both sides which allows the fluid flow in a rhythmic pendulum motion using pendulum motion unit on the subject's forehead indicated as bowl oscillation movement 04 (224).

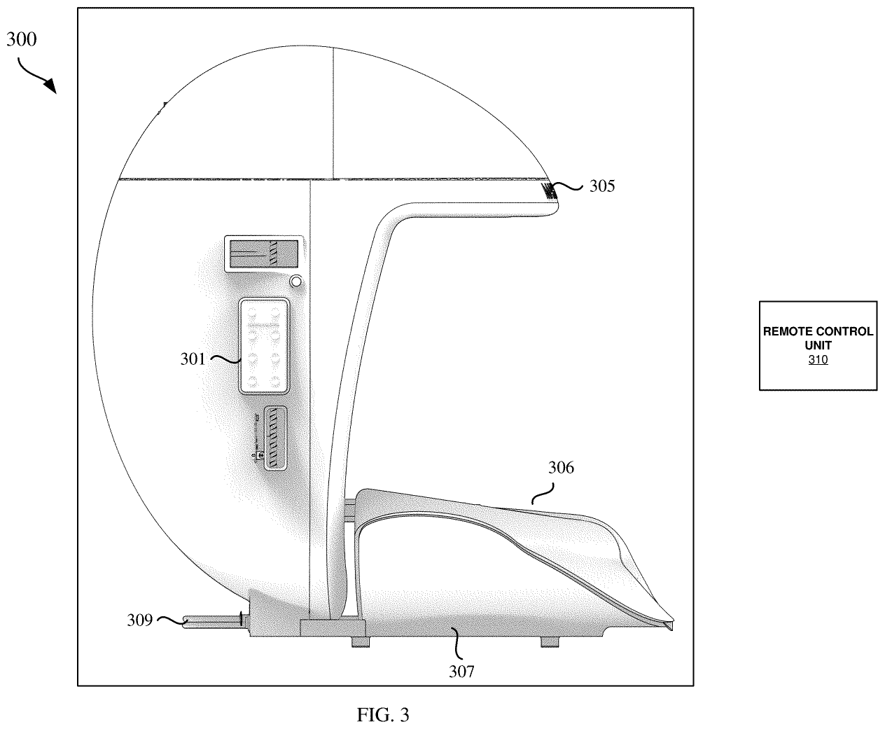

FIG. 3 is a schematic view illustrating the shirodhara healing method is performed using the portable shirodhara device in an embodiment of the present disclosure. As shown in 300, is a portable shirodhara device where shirodhara healing is performed without man intervention throughout the entire procedure. The fluid heater unit warms up the selected fluid administered in a fluid container unit 303 constantly to desirable temperature preferably 38+ or −5° C. and maintains the same temperature till the entire process of treatment. The fluid container unit that contains a selected fluid usually oil or combination of oils, milk, buttermilk or water based on the patient's body requirements and condition. The motor unit with stepper motor to pump the warmed fluid from the fluid container unit to a fluid dispenser unit. The patient is made to lie down on the head rest unit 306 where the fluid dispenser unit 305 with dispensing bowl flows the warmed selected fluid either perpendicularly or across or in a rhythmic pendulum motion using pendulum motion unit on the subject's forehead. Then the fluid gets collected in the fluid collection unit 307 with collection tray which is the pumped back to the fluid container unit through flow pipes which gets warmed again by the fluid heater unit and pumped to the fluid dispenser unit. The remote-control unit 310 connected to the portable shirodhara device 300 through Bluetooth or WIFI to control the entire operation of the device remotely.

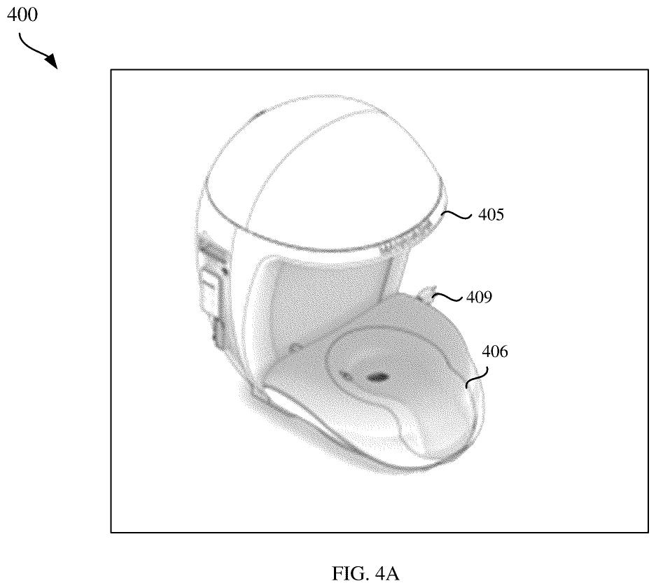

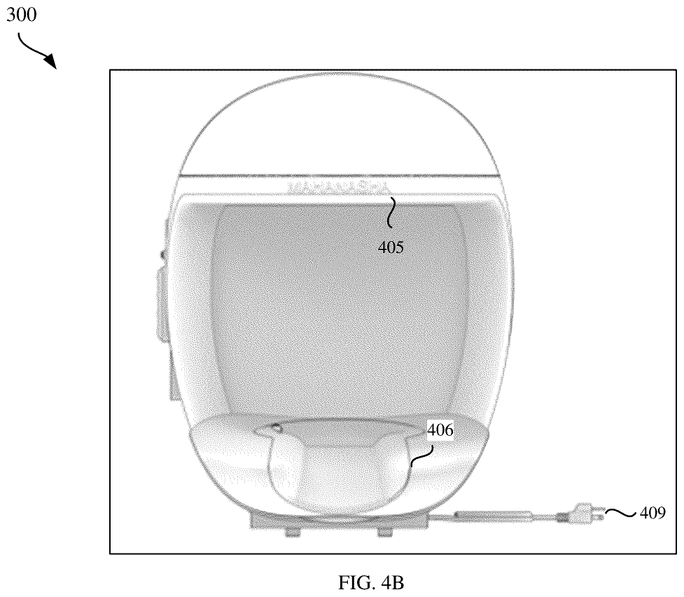

FIG. 4A and FIG. 4B are schematic view illustrating the head position during shirodhara healing is performed using the portable shirodhara device in an embodiment of the present disclosure. As shown in 400 and 411, initially the patient is made to lie down resting his/her head on the head rest unit with head rest cushion where the fluid dispenser unit 405 with dispensing bowl that flows the warmed fluid either perpendicularly or across or in a rhythmic pendulum motion using pendulum motion unit on the subject's forehead in lateral direction. The fluid dispenser unit 405 is adjusted up to 15 cms above the subject's forehead. Thus, this device is suitable for all age groups to perform shirodhara treatment.

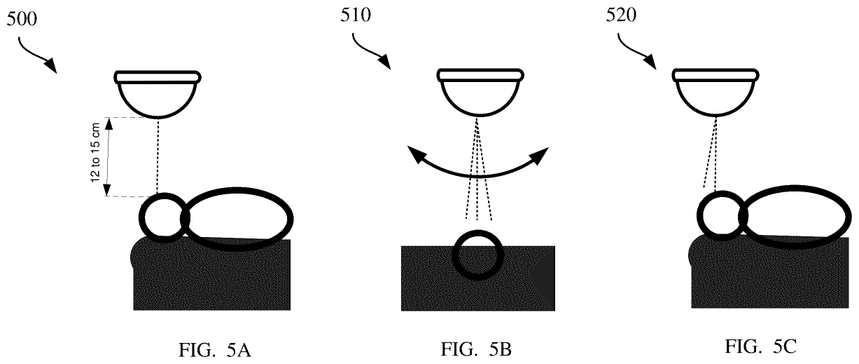

FIG. 5A through FIG. 5C are schematic view of the pendulum motion unit illustrating the dispensing bowl movement of the portable shirodhara device in an embodiment of the present disclosure. As shown in 500, shows that the distance between the subject's forehead shirodhara tip point where the fluid dispenser unit with dispensing bowl is at its initial position. Here the warmed fluid from the dispensing bowl is flowing perpendicularly on the subject's forehead.

As shown in 510, the dispensing bowl is allowing the fluid to flow in a rhythmic pendulum motion using pendulum motion unit on the subject's forehead indicated as bowl oscillation movement 04.

As shown in 520, the dispensing bowl is allowing the warmed fluid to flow across the subject's forehead.

In an embodiment, the dispensing bowl release the warm liquid from a set height, and swing the apparatus in a rhythmic pendulum motion in lateral direction to create a soothing oscillating flow across subject's forehead. The liquid is allowed to stream from the forehead over the subject's scalp and through the hair. The dispensing bowl is moved so the liquid flows along the hairline.

In an embodiment, the portable shirodhara device is easy to install with digital temperature regulator and digital timer for precision accuracy. This device is user-friendly and compatible with different viscous fluids.

In an embodiment, the continuous flow of warm liquid on the forehead for such a long period causes mild vasodilatation. This shirodhara treatment help in regularization the blood supply of the brain. The constant pressure and vibration produced in the shirodhara procedure also works as an anti-stress effect of Shirodhara.

While various embodiments of the present disclosure have been described above, it should be understood that they have been presented by way of example only, and not limitation. Thus, the breadth and scope of the present disclosure should not be limited by any of the above-discussed embodiments, but should be defined only in accordance with the following claims and their equivalents.

What is claimed is:

1. A portable shirodhara device (200) comprising:
a control unit 201 to control the entire operation of the device;
a fluid heater unit 202 configured with a temperature and a timer sensor, warms up a selected fluid administered into a fluid container unit 203 constantly to desirable temperature preferably 38+ or −5° C. and maintains the same temperature till the entire process of treatment;
a fluid container unit 203 with a selected fluid usually oil or combination of oils, milk, buttermilk or water based on the subject's body requirements and condition;
a motor unit 204 to pump the warmed fluid from the fluid container unit 203 to a fluid dispenser unit 205;
a fluid dispenser unit 205 flows the warmed fluid on the adjusted forehead just four fingers (4 Angola˜approximately. 6 inches) above the subject's forehead in a rhythmic pendulum motion in lateral direction;
a pendulum motion unit 206 makes the fluid dispenser unit 205 to allow the fluid flow either perpendicularly or across or in a rhythmic pendulum motion on the subject's forehead;
a head rest unit 207 where the subject's head is rested for the fluid to flow from the fluid dispenser unit 205 on the forehead just four fingers (4 Angola˜approximately. 6 inches) above the subject's forehead;
a fluid collection unit 208 used to collect the fluid that flows from the fluid dispenser unit 205 above the subject's forehead;
a pump unit 209 used to pump the collected fluid from the fluid collection unit 208 back to the fluid container unit 203 which gets warmed again by the fluid heater unit 202 and pumped to the fluid dispenser unit 205;
a power unit 210 provides power from the external sources to activate the entire operation of the portable shirodhara device 200;
a remote-control unit 211 connected to the portable shirodhara device 200 through Bluetooth or WIFI to control the entire operation of the device remotely,
wherein the portable shirodhara device 200 is used to achieve a minimizing usage of fluids and man power for the procedure of shirodhara treatment.
